(19) United States
(12) Patent Application Publication
(10) Pub. No.: US 2025/0369474 A1
(43) Pub. Date: Dec. 4, 2025

(54) JOINERY ARRANGEMENT COMPRISING INTERLOCKED JOINERY COMPONENTS

(71) Applicant: Välinge Innovation AB, Viken (SE)

(72) Inventors: Henrik LINDQUIST, SKUMMESLÖVSSTRAND (SE); Peter DERELÖV, HELSINGBORG (SE); Hans BRÄNNSTRÖM, HÖGANÄS (SE)

(73) Assignee: Välinge Innovation AB, Viken (SE)

(21) Appl. No.: 19/226,620

(22) Filed: Jun. 3, 2025

(30) Foreign Application Priority Data
Jun. 4, 2024 (SE) 2450604-01

(51) Int. Cl. F16B 12/50; A47B 88/90

(52) U.S. Cl. CPC F16B 12/50; A47B 88/941; A47B 2230/0037; A47B 2230/07

(57) ABSTRACT

A joinery arrangement including a first and a second joinery component configured to be locked to each other. The first joinery component includes at least one cavity and a recess and the second joinery component includes at least one connection member and a displaceable and/or compressible insert. The cavities and the connection members are configured to cooperate with each other for locking the first and second joinery components to each other in a first direction and the recess and the insert are configured to cooperate with each other for locking the first and second joinery components to each other in a second direction. The cavities and connection members are configured to transition from an uncoupled state to a coupled state and/or vice versa by a relative displacement of the first and second joinery components along a coupling direction.

### CROSS REFERENCE TO RELATED APPLICATIONS

The present application claims the benefit of Swedish Application No. 2450604-0, filed on

Jun. 4, 2024. The entire contents of Swedish Application No. 2450604-0 are hereby incorporated herein by reference in their entirety.

### TECHNICAL FIELD

The disclosure relates to a joinery arrangement comprising joinery components configured to be locked to each other. The joinery arrangement may be included in a joinery assembly, such as a furniture assembly. The disclosure also relates to a joinery assembly comprising the joinery arrangement and additional joinery components.

### BACKGROUND

At least parts of furniture joints are customarily connected using interference fits. In particular, such connections may utilize dowels and holes or similar elements that are slidingly connectable to each other.

WO 2020/027712 A1 discloses a connection arrangement for connecting a first furniture part to a second furniture part. The first furniture part comprises a primary dowel and a secondary dowel, and the second furniture part comprises a primary recess and a secondary recess. At least the primary recess further comprises an end portion configured to interact with the primary dowel and to provide an end position in a motion of the first furniture part along a transverse direction relative to the second furniture part.

The disclosure WO 2023/144640 A1, which is a further development of parts of the teachings in WO 2021/245591 A1, describes a connecting system comprising a stud having an anchoring portion which may be inserted inside a hole made in a first component of a piece of furniture, a stem departing from the anchoring portion along an insertion direction, and a head. A slot is made in a second component of the piece of furniture and extends along a tightening direction transversal to the insertion direction. The slot has an insertion portion such as to allow the introduction of the head of the stud into the slot along the insertion direction and a retaining portion provided with an abutment shoulder extending along the tightening direction and being shaped to prevent the head from coming out along the insertion direction.

However, unless the connecting system is carefully manufactured, the existing connecting systems, such as of the types above, may typically be difficult to assemble. In addition, the locking performance may be unsatisfactory, oftentimes being prone to involuntary unlocking of the furniture components.

### SUMMARY

It is therefore an object of at least embodiments of the present disclosure to provide a joinery arrangement with a more reliable locking configuration.

Another object of at least embodiments of the present disclosure is to provide a joinery arrangement which is more efficient and/or more cost effective to manufacture.

Yet another object of at least embodiments of the present disclosure is to provide a corresponding joinery assembly comprising such a joinery arrangement.

These and other objects and advantages that will be apparent from the description have been achieved by the various aspects, embodiments and examples described below.

In accordance with a first aspect of the disclosure, there is provided a joinery arrangement comprising a first joinery component and a second joinery component configured to be locked to each other to obtain a locked state. A mounting side of the first joinery component comprises at least one cavity and a recess, and a mounting area of the second joinery component comprises at least one protruding connection member and an insert, wherein the insert is displaceable and/or compressible along its main direction. The at least one cavity and the at least one connection member are configured to transition from an uncoupled state to a coupled state and/or configured to transition from the coupled state to the uncoupled state by a relative displacement of the first and second joinery components along a coupling direction extending along a first plane extending along the mounting side of the first joinery component. The at least one cavity and the at least one connection member comprise a locking member and a locking element configured to cooperate with each other in the coupled state for locking the first and second joinery components to each other in a first direction perpendicular to the first plane. The recess and the insert are configured to cooperate with each other in the coupled state for locking the first and second joinery components to each other in a second direction along the first plane.

By means of the first aspect, the locking function of the joinery components may be separated into two parts. Indeed, the connection members and the cavities may provide locking in the first direction, and optionally a third direction which is perpendicular to the first and/or second directions, while the insert and the recess may provide locking in the second direction. As a result, the two parts of the locking function may be adjusted independently from each other. Thereby, larger dimensional tolerances may be allowed. Hence, the locking function between the joinery components may become more reliable. Additionally, the joinery arrangement may become easier and faster, and hence more efficient, to manufacture. For example, as will be explained in more detail elsewhere herein, the path of a processing tool, for example a milling tool, may at least in some applications be shortened significantly. This may also make the manufacturing even more cost efficient.

The joinery arrangement may be included in a joinery assembly, such as a furniture assembly. For example, the furniture assembly may be a cabinet assembly, a drawer assembly or a shelf assembly.

The joinery components herein may be furniture components, such as cabinet components, drawer components or shelf components. For example, the joinery components may be panels.

The joinery components herein may be wood-based joinery components, preferably comprising a core and, optionally, a décor structure, such as a décor layer attached, for example adhered, to the core. For example, the core may be a high-density fibre, HDF, board, a medium-density fibre, MDF, board, a particle board, solid wood, or a plywood board. The joinery components may generally herein comprise at least one layer, such as at least two layers. For example, one layer or at least two layers may be the core. Moreover, the décor structure may be or may comprise a décor layer, such as a foil, a paper, a polymer-based layer, a laminated layer, or a wood veneer. Alternatively, or additionally, the décor structure may comprise a painted surface layer. The cavities, the recess, the insert groove (defined below), and the holes for the connection members (defined below) may be arranged in the core.

The connection members may comprise a wood-based material or a polymer-based material.

The cooperation, such as engagement, between the cavities and the connection members as well as between the recess and the insert may define a locked state of the first and second joinery components. Furthermore, an unlocked state of the joinery components may be obtained when there is no cooperation between the cavities and the connection members and/or the recess and the insert.

For simplicity of the presentation herein, reference will often be made to “cavities” or “connection members” instead of “at least one cavity” or “at least one connection member”, but it is emphasized that “at least one cavity” or “at least one connection member”, “at least two cavities” or “at least two connection members” and “a plurality of cavities or a plurality of connection members” are included in the concept of “cavities” or “connection members”. Similar statements are valid for other objects herein, such as projections, grooves and locking surfaces.

Generally herein, cooperating objects, such as surfaces, portions, members or elements, may cooperate by direct engagement or indirectly. Examples of cooperating objects include the cavities and connection members, and the recess and the insert. In any embodiment described herein, there may be an intermediate member provided between the cooperating objects, thereby providing examples of an indirect engagement. For example, the intermediate member may be a sealing agent, such as a wax or an adhesive.

A width of the cavity may vary along a longitudinal cavity direction. A width of the connection member may vary along a longitudinal direction of the connection member. Thereby, the locking in the first direction may be obtained.

The locking member and the locking element may comprise at least one projection and at least one groove, such as at least two projections and at least two grooves. This may embody the varying widths of the cavities and/or connection members.

The locking member and the locking element may comprise at least two pairs of locking surfaces for locking the first and second joinery components to each other in the first direction. Thereby, at least in some embodiments, a stronger locking function may be obtained. In addition, an improved load distribution in the joinery components, such as in more than one layer, may be obtained.

In some embodiments, the locking member and the locking element may comprise a single pair of locking surfaces for locking in the first direction.

In any of the embodiments above, the locking surfaces of each pair may be arranged at an angle s of 0°-70°, such as 20°-70° or 30°-60°, with respect to the first plane.

The at least one cavity, such as a receiving portion thereof, may be configured to receive the at least one connection member by a relative displacement of the first and second joinery components along a locking direction extending along the first direction, such as only along the first direction.

The at least one cavity and the at least one connection member may be further configured to cooperate with each other for locking the first and second joinery components to each other along the second direction, preferably in a direction opposite to the second direction in which the recess and the insert are configured to lock. Thereby, the joinery components may be locked to each other in the second direction and in a direction opposite to the second direction.

Each cavity may comprise a receiving portion and a coupling portion. The connection members may be received in the respective receiving portion such that the cavities and the connection members may be positioned in the uncoupled state. The connection members may be received in the cavities before relatively displacing the first and second joinery components along the coupling direction for obtaining the coupled state. For example, the cavities may be substantially shaped as a keyhole.

The receiving portion may be configured to house the connection member. The receiving portion may be shaped such that it may receive the connection member and position it in the uncoupled state.

In some embodiments, a width of the cavity along the coupling direction does not exceed 2.5, such as not exceeding 2.0, times a width of the receiving portion along the coupling direction. In some embodiments, the width of the cavity may not exceed 1.75, such as not exceeding 1.5, times the width of the receiving portion along the coupling direction. For example, a ratio between the width of the cavity and of the receiving portion (V1/WR) may be from above 1.0 to 2.0, such as from above 1.0 to 1.75 or from above 1.0 to 1.5. In accordance with any of these embodiments, shorter cavities may be formed. The processing time for forming the cavities, such as by milling, may thereby be reduced significantly. Moreover, at least in some applications, such shorter cavities may be sufficient to ensure a satisfactory, or even excellent, overall locking strength of the joinery components. In addition, the shorter cavities may imply a shorter displacement during assembly of the joinery components. The tool wear may also be reduced when forming the shorter cavities. Another advantage of having shorter cavities is that the cavities may be positioned closer to each other, since less of an area of the mounting side needs to be processed. This may be advantageous for smaller panels, which thereby may become more rigid.

The mounting side of the first joinery component may be provided in a first face of the first joinery component. The mounting area may be provided in a first side edge of the second joinery component.

The mounting side of the first joinery component may comprise at least two cavities. The mounting area of the second joinery component may comprise at least two connection members.

The joinery components may be configured such that each connection member may be received in a respective cavity, preferably in the receiving portion, such that each pair of connection members and cavities may be positioned in the uncoupled state. Moreover, each pair of cavities and connection members may transition to the coupled state by the relative displacement of the first and second joinery components along the coupling direction.

A longitudinal direction of the at least one connection member may extend along a normal direction of a second plane extending along the mounting area of the second joinery component.

The at least one cavity and the at least one connection member may be further configured to cooperate with each other in the coupled state for locking the first and second joinery components to each other in a third direction, preferably also in a direction opposite to the third direction. Preferably, the third direction is perpendicular to the first and second directions. Thereby, a locking along three perpendicular directions may be provided.

The coupling direction may extend along the second direction.

During locking, the insert may be configured to be compressed such that it assumes a compressed state, and, subsequently, the insert may be at least partially expanded towards an expanded state for locking the second joinery component to the first joinery component. For example, the insert may lock against the recess by pretension.

The mounting side and the mounting area may be configured to cooperate with each other in the uncoupled state and/or during the relative displacement of the first and second joinery components along the coupling direction.

The second joinery component may be configured to be locked to the first joinery component by relatively displacing the second joinery component with respect to the first joinery component along the coupling direction.

The insert may be separately formed from the second joinery component. For example, the insert, including a body portion and serpentine elements (defined below), may be integrally formed, such as by injection moulding. Such an insert may be easier and/or cheaper to manufacture. Also, recycling of the insert may become simpler. The insert may comprise a polymer-based material.

The insert may be arranged in an insert groove of the second joinery component.

The second joinery component may comprise an unlocking hole configured to communicate with the insert groove for providing access to an opening of the insert. The first and second joinery components may be configured to be unlocked by inserting a tool into the unlocking hole and through the opening.

The insert and/or an insert groove in which the insert is configured to be arranged may essentially extend along a normal direction of a second plane extending along the mounting area of the second joinery component. Thereby, it may become easier to form the insert groove, such as by drilling.

The insert may comprise a spring, such as a static load spring.

The insert may comprise a plurality of joined serpentine elements. The serpentine elements may be flexible and may implement a compressibility of the insert along the main direction, such as axial direction. The serpentine elements may be connected to a body portion of the insert in an integral manner. Preferably, the serpentine elements are exposed, such that they are visible around their entire circumference.

The insert may comprise a locking portion and an outer portion arranged opposite to the locking portion. In the locked state, the locking portion may be configured to cooperate with a locking surface of the recess arranged in a recess wall for locking the first and the second joinery components in the second direction, and, moreover, the outer portion may be spaced from an oppositely arranged recess wall by a play.

A head portion of the insert may be generally tapering, such as comprising a frustoconical head surface.

A compressible member of the insert, preferably in the form of a plurality of joined serpentine elements, may be configured such that its width does not substantially increase during compression of the insert. Thereby, a risk of pinching the compressible member against walls of the insert groove when it is compressed may be reduced or entirely avoided. A more failsafe locking function may thereby be provided.

A cross-section of the recess and/or the receiving portion of the cavities may be circular. For example, walls of the recess and/or the receiving portion may be substantially cylindrically or frustoconically shaped.

In accordance with a second aspect of the disclosure, there is provided a joinery assembly comprising the joinery arrangement according to any of the embodiments of the first aspect and further comprising at least one additional joinery component, such as a plurality of additional joinery components. Embodiments of the second aspect are largely analogous to those of the first aspect, especially embodiments of the joinery arrangement, whereby reference is made thereto.

The joinery assembly may be a furniture assembly, such as a cabinet assembly, a drawer assembly or a shelf assembly.

In some embodiments, the components of the joinery arrangement of the first aspect may be provided as a kit-of-parts configured to be assembled to each other. Such a kit-of-parts may be arranged in a package and may easily be transported to a location where the joinery arrangement or joinery assembly may be assembled. In fact, in accordance with a third aspect of the disclosure, there is provided a kit-of-parts comprising the first and a second joinery components, the connection members and the insert of the first aspect. Embodiments of the third aspect are largely analogous to those of the first aspect, whereby reference is made thereto.

Generally, all terms used herein, such as in the claims, are to be interpreted according to their ordinary meaning in the technical field, unless explicitly defined otherwise. All references to “a/an/the [element, device, component, means, step, etc.]” are to be interpreted openly as referring to at least one instance of said element, device, component, means, step, etc., unless explicitly stated otherwise. Reference to one or a plurality of “at least one element”, etc., may shortly be referred to as “the element(s)”.

### BRIEF DESCRIPTION OF THE DRAWINGS

The disclosure will in the following be described in connection to exemplary embodiments and in greater detail with reference to the appended exemplary drawings, wherein:

FIGS. 1a-1c illustrate in a front view (FIG. 1a), side view (FIG. 1b), and a cross-sectional front view (FIG. 1c) along the section B-B in FIG. 1b an embodiment of a joinery arrangement during locking.

FIGS. 2a-2d illustrate the embodiment in FIGS. 1a-1c in a perspective view (FIG. 2a), a transparent perspective view (FIG. 2b), and in cross-sectional front views along the section B-B at a later stage of the locking (FIG. 2c) and in a locked state (FIG. 2d).

FIGS. 3a-3b illustrate the embodiment in FIG. 2d in an enlarged cross-sectional front view (FIG. 3a) and in a sectional top view (FIG. 3b) an embodiment of the first joinery component.

FIGS. 3c-3e illustrate in top views embodiments of the cavities, e.g., in FIGS. 1a-1c, 2a-2d, 3a-3b and 4a-4b (FIG. 3c), in FIGS. 5a-5c, 6a-6d and 7a-7b (FIG. 3d), and in FIGS. 8a-8b (FIG. 3e), but that are conceivable in any embodiment of the joinery arrangement herein.

FIGS. 4a-4c illustrate in a perspective view (FIG. 4a), a transparent perspective view (FIG. 4b) and a side view (FIG. 4c), the embodiment in, e.g., FIGS. 1a-1c and 2a-2d in a locked state.

FIG. 4d illustrates in an enlarged cross-sectional front view an embodiment of a second joinery component without any insert and without any connection member.

FIGS. 5a-5c illustrate in a front view (FIG. 5a), a side view (FIG. 5b), and a cross-sectional front view (FIG. 5c) along the section B-B in FIG. 5b an embodiment of a joinery arrangement during locking.

FIGS. 6a-6d illustrate the embodiment in FIGS. 5a-5c in a perspective view (FIG. 6a), a transparent perspective view (FIG. 6b), and in cross-sectional front views along the section B-B at a later stage of the locking (FIG. 6c) and in a locked state (FIG. 6d).

FIGS. 7a-7b illustrate the embodiment in FIG. 6d in an enlarged cross-sectional front view (FIG. 7a) and in a transparent perspective view (FIG. 7b) the embodiment in, e.g., FIGS. 5a-5c and 6a-6d, in a locked state.

FIGS. 7c-7d illustrate in side views an embodiment of an insert in an expanded state (FIG. 7c) and in a compressed state (FIG. 7d).

FIGS. 8a-8b illustrate in a cross-sectional front view (FIG. 8a) along the section B-B similarly to FIG. 5b and in a perspective view (FIG. 8b) another embodiment of a joinery arrangement during locking.

FIGS. 8c-8f schematically illustrate in top views and/or cross-sectional top views embodiments of connection member geometries.

FIGS. 9a-9c illustrates in cross-sectional front views an embodiment of a disassembly of the joinery components.

FIGS. 10a-10b illustrates in a top view (FIG. 10a) an embodiment of a cavity and in a transparent perspective view (FIG. 10b) the cavity and a connection member.

FIG. 10c illustrates in a perspective view an embodiment of a joinery assembly in an assembled state, e.g., including any of the joinery arrangements and/or inserts in FIGS. 1a-1c, 2a-2d, 3a-3e, 4a-4d, 5a-5c, 6a-6d, 7a-7c, 8a-8f, 9a-9c, 10a-10b and 10d.

FIG. 10d illustrates in a transparent perspective view an embodiment of a joinery arrangement in a locked state.

### DETAILED DESCRIPTION

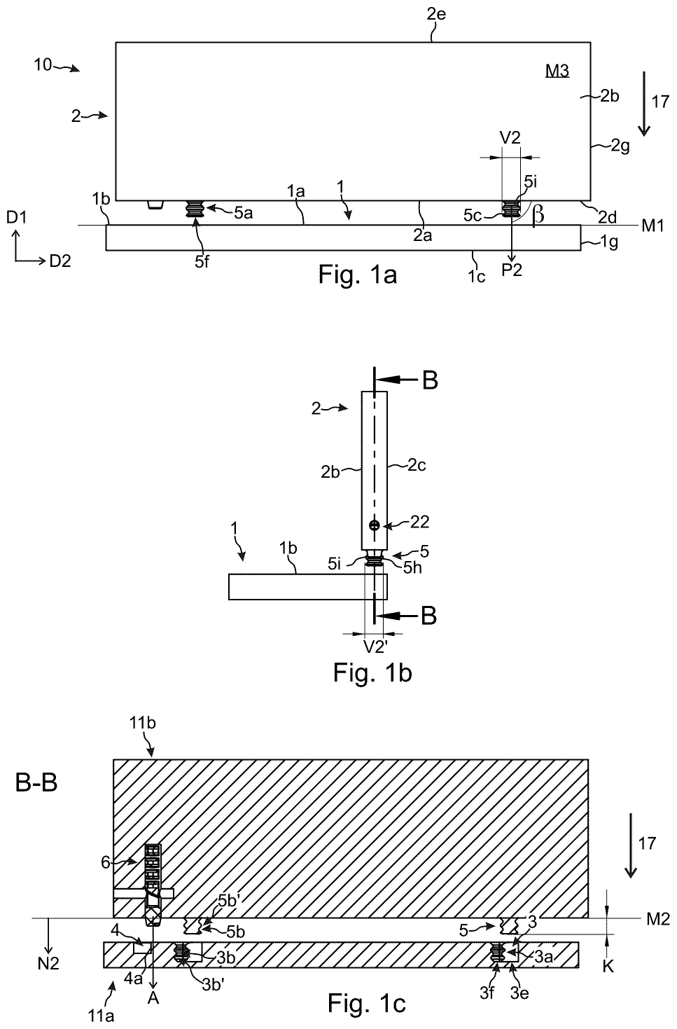

Next, various embodiments of a joinery arrangement 10 and a corresponding joinery assembly 20 will be described with reference to, e.g., FIGS. 1a-1c, 2a-2d, 3a-3e, 4a-4d, 5a-5c, 6a-6d, 7a-7d, 8a-8f, 9a-9c and 10a-10d.

The disclosure relates to a joinery arrangement 10 comprising a first 1 and a second 2 joinery component. The joinery components 1, 2 may be furniture components, such as cabinet components, drawer components or shelf components. For example, the joinery components may be panels, such as furniture panels.

The first (or second) joinery component 1 (or 2) may comprise a first face 1b (or 2b) and a second face 1c (or 2c) opposite to the first face 1b (or 2b). Moreover, the first (or second) joinery component 1 (or 2) may further comprise a pair of opposing first 1d (or 2d) and second 1e (or 2e) side edges and a pair of side portions 1f, 1g (or 2f, 2g) extending between the faces 1b, 1c (or 2b, 2c) and between the side edges 1d, 1e (or 2d, 2e).

The first 1 and/or the second 2 joinery components may be wood-based joinery components, preferably comprising a core 18 and, optionally, a décor structure 19, such as a décor layer attached to the core 18. For example, the core 18 may be an HDF board, an MDF board, a particle board, a HPL board, solid wood, or a plywood board. Moreover, the décor layer may be or may comprise a foil, a paper, polymer-based layer, a laminated layer, or a wood veneer. For example, the polymer-based layer may comprise a thermosetting resin, such as a melamine-formaldehyde resin, or thermoplastic polymers, such as polyvinyl chloride, PVC. Alternatively, or additionally, the décor structure 19 may comprise a painted surface layer.

The first joinery component 1 comprises at least one cavity 3, such as at least two or a plurality of cavities 3, and a recess 4. The cavities 3 are arranged in a mounting side 1a of the first joinery component 1 and extend along a longitudinal cavity direction P1 at a cavity angle [symbol] with respect to a first plane M1 extending along the mounting side 1a. The mounting side 1a may be provided in the first face 1b. Preferably, the cavity angle [symbol] is about 90°, such that the cavities 3 extend along a normal direction N1 of the first plane M1. The recess 4 also is arranged in the mounting side 1a. The cavities and/or the recess may be formed by milling and/or drilling.

The second joinery component 2 comprises at least one protruding connection member 5, such as at least two or a plurality of protruding connection members 5, and an insert 6. The connection members 5 are arranged in a mounting area 2a of the second joinery component 2 and extend along a longitudinal direction P2 of the connection member 5 at a connection angle b with respect to a second plane M2 extending along the mounting area 2a. The mounting area 2a may be provided in the first side edge 2d. Preferably, the connection angle b is about 90°, such that the connection member 5 extends along a normal direction N2 of the second plane M2. For example, the directions P1, P2 may be parallel.

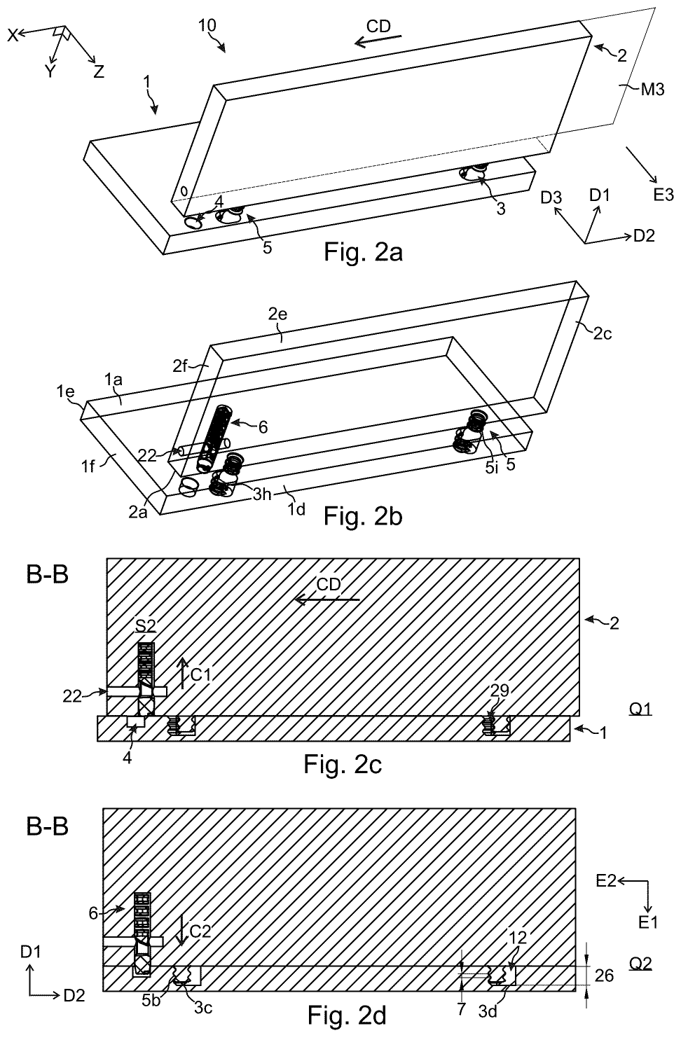

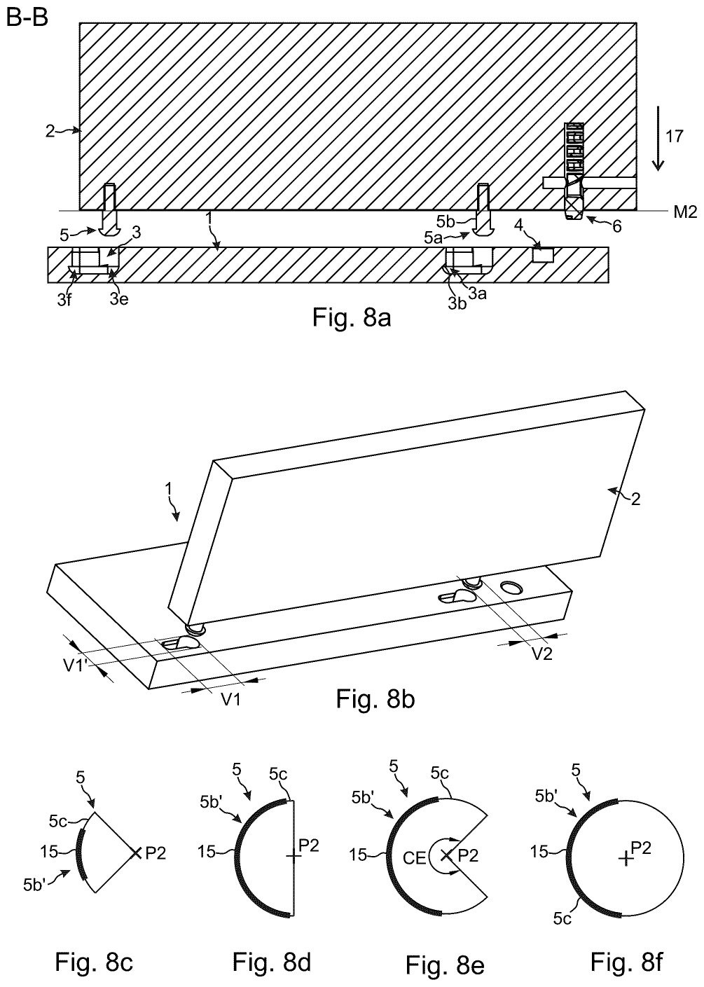

The connection members 5 may be axially rigid. Thereby, they may be substantially incompressible along their axial directions, preferably being parallel with the longitudinal direction P2. For example, a top portion 5f, such as a projection 3b, 5b′ (see below), of the connection members 5 may be rigid, such that they do not substantially bend during and/or after locking. The connection members 5 may be arranged in a hole 5d, preferably by means of a press fit and/or an adhesive, or by other fastening means, for example wood welding, ultrasonic fastening, or an anchor device, such as a screw or an anchoring portion such as that disclosed in WO 2023/144640 A1, page 7, lines 17-24. The holes 5d may be formed by drilling and may be inclined by an angle corresponding to the connection angle b, preferably being about 90°. As shown most clearly in FIGS. 2b, 4b, 6b, 7b, 8f, 10b and 10d, a cross-section of each connection member 5 along the longitudinal direction P2 preferably is circular, but other cross-sectional shapes are equally conceivable, see FIGS. 8c-8e and the discussion further below. Preferably, the connection members 5 are separately formed from the second joinery component 2. For example, they may be plugs or dowels, preferably polymer-based dowels or wood dowels.

In preferred embodiments, the cavities 3 are essentially identical and the connection members 5 are essentially identical. However, varying shapes of the cavities 3 and/or connection members 5 are equally conceivable.

The insert 6 is arranged in the mounting area 2a and is preferably arranged in an insert groove 9 of the second joinery component 2. The insert 6 is displaceable and/or compressible along its main direction A, such as by being spring loaded. The main direction A may be an axial direction of the insert.

A, preferably maximal, length K of the protruding connection members 5 and/or a depth 26 of the cavities 3 may be 5-30 mm, such as 8-20 mm. A, preferably maximal, width V1′ of the cavities 3 may be 6-16 mm, preferably 8-11 mm. A, preferably maximal, width V2, V2′ of the connection members 5 may be 6-16 mm, preferably 8-11 mm. (The widths V1, V1′, V2, V2′ are discussed further below.) A, preferably maximal, width W1, W2 of the insert 6 and/or insert groove 9 may be 5-12 mm, such as 5-10 mm or 8-12 mm. Likewise, a preferably maximal, width W3 of the recess 4 may be 5-12 mm, such as 7-11 mm or 8-12 mm.

As illustrated in, e.g., FIGS. 2c-2d, 3a, 4a-4b, 6c-6d and 7a-7b, the cavities 3 and the connection members 5 are configured to transition from an uncoupled state Q1 to a coupled state Q2 and/or configured to transition from the coupled state Q2 to the uncoupled state Q1 by a relative displacement of the first 1 and second 2 joinery components along a coupling direction CD extending along the first plane M1.

The cavities 3 and connection members 5 comprise a locking member 3a and a locking element 5a, respectively, configured to cooperate, such as engage, with each other in the coupled state Q2 for locking the first 1 and second 2 joinery components to each other in a first direction D1 perpendicular to the first plane M1. Each connection member 5 may be received in a respective cavity 3 for cooperation therebetween. For example, the connection members 5 may protrude from the second plane M2 along the first direction D1 and/or the cavities 3 may extend inwardly from the second plane M2 along the first direction D1.

Moreover, the recess 4 and the insert 6 are configured to cooperate, such as engage, with each other in the coupled state Q2 for locking the first 1 and second 2 joinery components in a second direction D2 along the first plane M1. Preferably, the coupling direction CD extends along the second direction D2. The second direction D2 may extend along the side edges 1d, 1e, preferably along their largest dimensions.

Thereby, a locked state of the first 1 and second 2 joinery components in the first D1 and second D2 directions may be obtained, see, e.g., FIGS. 2d, 3a, 4a-4b, 6d, 7a-7b, 9a and 10c-10d. Preferably, the first D1 and second D2 directions are perpendicular to each other. The cavities 3 and connection members 5 together with the recess 4 and the insert 6 may provide a locking device of the joinery arrangement 10.

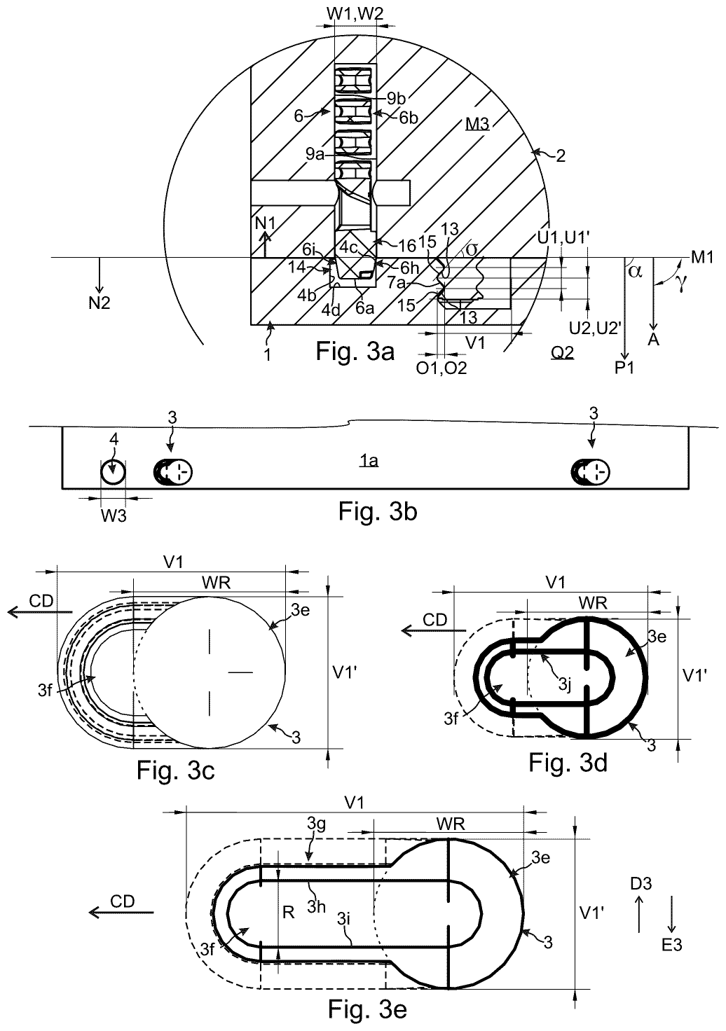

Preferably, a width V1, V1′ of the cavities 3 varies along the longitudinal cavity direction P1 and the width V2, V2′ of the connection members 5 varies along the longitudinal direction P2. More specifically, the widths V1, V2 and/or V1′, V2′ along the second direction D2 and/or a third direction D3 may vary. Preferably, the third direction D3 is perpendicular to the first D1 and second D2 directions. The locking member 3a and the locking element 5a may comprise at least one projection 3b, 5b′ and at least one groove 3b′, 5b, such as at least two projections and at least two grooves, for example being arranged in a cavity wall 3c of the cavities 3 and in a side wall 5c of the connection members 5. In a first example, as illustrated in FIGS. 1a-1c, 2a-2d, 3a-3c, 4a-4c, 9a-9c, 10a-10b and 10d, the locking member 3a may comprise at least one projection 3b and at least one groove 3b′ and the locking element 5a may comprise at least one projection 5b′ and at least one groove 5b, for example the locking member and the locking element each comprising at least two projections and at least two grooves. In a second example, as illustrated in FIGS. 3d-3e, 5a-5c, 6a-6d, 7a-7b and 8a-8b, the locking member 3a may comprise a single projection 3b and a single groove 3b′ and the locking element 5b may comprise a single projection 5b′ and a single groove 5b. Here, at least a base portion 5e of each protruding connection member 5 may comprise a rod-shaped element, such as a cylinder-shaped element.

The widths V1, V2, V1′, V2′ may be determined along a transverse direction perpendicular to the longitudinal cavity direction P1 or longitudinal direction P2, such as the widths V1, V2 being determined along the second direction D2 and/or the coupling direction CD. Alternatively, or additionally, the widths V1′, V2′ may be determined along the third direction D3, for example along or, in the case of the width R at, the transition portion 3g (defined below).

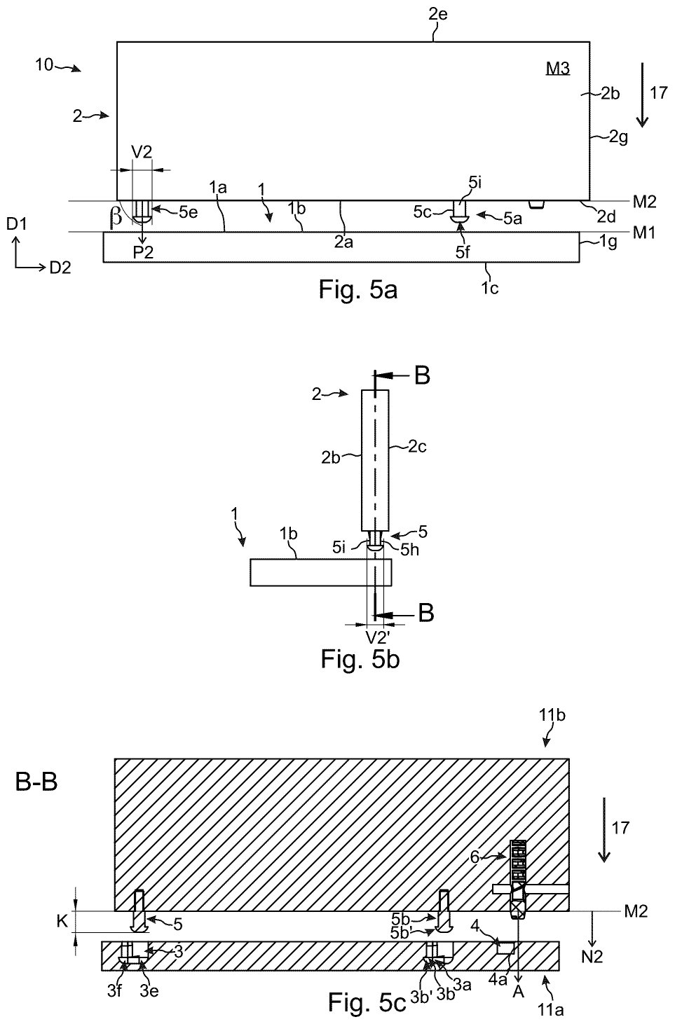

Each pair of projections 3b, 5b′ and grooves 5b, 3b′ may comprise locking surfaces 13, 15 for locking the first 1 and second 2 joinery components to each other in the first direction D1. In some embodiments, and as shown in, e.g., FIGS. 5a-5c, 6a-6d, 7a-7b and 8a-8b, the locking member 3a and the locking element 5a may comprise a single pair of locking surfaces 13, 15. For example, the locking surface 13 and/or the locking surface 15 may be arranged at an angle s of 0°-30°, such as 0°-20°, with respect to the first plane M1. In some embodiments, and as shown in, e.g., FIGS. 1a-1c, 2a-2d, 3a-3e, 4a-4d, 9a-9c, 10a-10b and 10d, the locking member 3a and the locking element 5a may comprise at least two pairs of locking surfaces 13, 15. For example, the locking surface 13 and/or the locking surface 15 of each pair may be arranged at an angle s of 0°-70°, such as 20°-70° or 30°-60°, with respect to the first plane M1. The pairs 13, 15 of locking surfaces may be separated by a distance 7, preferably along the first direction D1. Optionally, there may be a play 7a between the pairs 13, 15 of locking surfaces. For example, the play 7a may be arranged between a portion of a projection 5b′ or a groove 5b facing outwards from the second joinery component 2 (e.g., in the direction E1 opposite to the first direction D1) and a portion of a projection 3b or a groove 3b′ facing outwards from the first joinery component 1 (e.g., in the first direction D1).

There may be a gap 29 between the locking surfaces 13, 15 when the locking member 3a begins to cooperate with the locking element 5a during locking. When the joinery components 1, 2 are further displaced relative to each other along the coupling direction CD, the locking surfaces 13, 15 may become tightly connected, cf. FIG. 2c. The gap 29 may extend along the second direction D2.

In a first example, the angle s of the single pair or the at least two pairs of locking surfaces 13 and 15 may be the same. In a second example, the angle s of the single pair or the at least two pairs of locking surfaces 13 and 15 may differ.

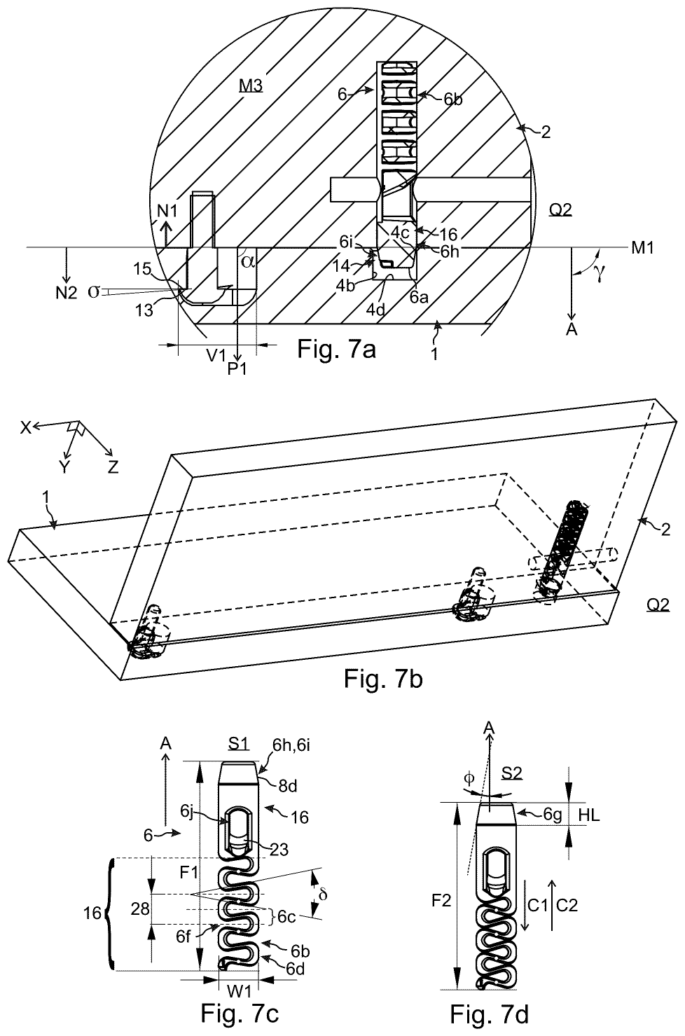

In non-restrictive examples, the locking surfaces 13 and 15 may cooperate along a distance of 1.5-5.0 mm, such as 2.5-4.0, see, for example, FIGS. 3a and 7a.

The projections 3b, 5b′ and grooves 3b′, 5b may extend transversely to the cavity direction P1 and/or the longitudinal direction P2. The projections and/or grooves may extend around a portion of a circumference or around an entire circumference of the cavities 3, preferably of the coupling portion 3f (defined below), and/or connection members 5, see, e.g., FIGS. 3c-3e and 8c-8f. For example, a circumferential extension CE of the connection members 5 around the longitudinal direction P2 may be at least 45°, such as at least 90°, such as at least 180°. In some embodiments, the circumferential extension CE may be 360° such that the connection members 5 extend entirely around the longitudinal direction P2. In any of these examples, the locking element 5a may cooperate with the locking member 3a along at least 50% or at least 75% or even 100% of the circumferential extension CE, such as along at least 180° of the circumferential extension CE. Exemplary cooperating locking surfaces 15 of the connection members 5 are indicated in FIGS. 8c-8f by bold lines. The projections and/or grooves may angularly extend around at least a portion of the coupling portion 3f, such as along at least 45° or along its entirety.

As illustrated in FIG. 3a, adjacent projections 3b (or 5b′), such as their transversely outermost portions, may be separated from each other along the cavity direction P1 (or longitudinal direction P2) by a spacing U1 (or U2′). Alternatively, or additionally, adjacent grooves 5b (or 3b′), such as their transversely innermost portions, may be separated from each other along the longitudinal direction P2 (or cavity direction P1) by a spacing U2 (or U1′). For example, at least one, or all, of U1, U1′, U2 and U2′ may be 3-7 mm, such as 4-6 mm.

The first direction D1 may be directed from the first joinery component 1 towards the second joinery component 2. Preferably, the mounting side 1a and the mounting area 2a may cooperate for locking the first 1 and second 2 joinery components to each other in a direction E1 opposite to the first direction D1. In other words, they may cooperate for locking in a direction from the second joinery component 2 towards the first joinery component 1.

Preferably, the at least one cavity 3 and the at least one connection member 5 may be further configured to cooperate with each other for locking the first 1 and second 2 joinery components to each other along the second direction D2. For example, at least one, such as at least two, of the pairs of cavities 3 and connection members 5 may cooperate, such as engage, with each other in the coupled state Q2 for locking the first 1 and second 2 joinery components to each other in a direction E2 opposite to the second direction D2 in which the recess 4 and the insert 6 are configured to lock. For example, the cavity wall 3c and the side wall 5c may cooperate for providing the locking. Preferably, there is a gap 12 between the connection member 5 and an opposite cavity wall 3d.

Moreover, the at least one cavity 3 and the at least one connection member 5 may be further configured to cooperate with each other in the coupled state Q2 for locking the first 1 and second 2 joinery components to each other in the third direction D3, preferably also in a direction E3 opposite to the third direction D3. For example, the locking along the third direction D3 and/or E3 may be provided by a cavity wall 3i and/or 3h cooperating with a front 5i and/or rear 5h wall of the connection member(s) 5, respectively.

The cavities 3 may be elongated along the coupling direction CD. Each cavity 3 may comprise a receiving portion 3e and a coupling portion 3f. Preferably, a width V1 of the cavities 3 along the coupling direction CD does not exceed 2.5, such as not exceeding 2.0, times a width WR of the receiving portion 3e along the coupling direction CD. In some embodiments, the width V1 of the cavity may not exceed 1.75, such as not exceeding 1.5, times the width WR. For example, the ratio V1/WR may be from above 1.0 to 2.0, such as from above 1.0 to 1.75 or from above 1.0 to 1.5. Other examples include the intervals 1.2≤V1/WR≤2.0, such as 1.2≤V1/WR≤1.75 or 1.2≤V1/WR≤1.5. In the non-limiting embodiments shown in FIGS. 3c-3e, the ratio V1/WR is about 1.5, 1.6 and 2¼, respectively. Preferably, the difference V1−WR exceeds a maximal extension O1, O2 of the projections 3b, 5b′ and grooves 3b′, 5b along the coupling direction CD. For example, 10 mm≤V1≤30 mm, such as 12 mm≤V1≤24 mm, and 8 mm≤WR≤16 mm, such as 10 mm≤WR≤14 mm. Moreover, O1 and/or O2 may be 1.0-3.0 mm, such as 1.5-2.5 mm. The widths V1, WR, but also the widths V1′, V2, V2′ herein, may be maximal widths of the cavities 3 and the receiving portion 3e, such as being determined at the first face 1b.

Each receiving portion 3e may be shaped such that it may receive the respective connection member 5 and position it in the uncoupled state Q1. The receiving portion 3e may be configured to house the connection member 5. The volume occupied by the connection member 5 in the cavity 3, such as directly after the connection member 5 is received in the cavity 3, may define the receiving portion 3e. For example, the cross-sectional shape of the receiving portion may be circular or oval. The cavities 3 may be formed by milling. For example, the cavities 3 may be substantially shaped as keyholes. Preferably, the cavities 3 and/or the recess 4 are blind holes.

The connection members 5 may be received in the cavities 3 before relatively displacing the first 1 and second 2 joinery components along the coupling direction CD for obtaining the coupled state Q2.

The coupling portion 3f may comprise the projections 3b, 5b′ and grooves 3b′, 5b. Preferably, the receiving portion 3e does not comprise any projections and grooves.

The cavities 3, preferably the receiving portion 3e, may be configured to receive the connection members 5 by a relative displacement of the first 1 and second 2 joinery components along a locking direction 17 extending along the first direction D1, such as only along the first direction D1. For example, the locking direction 17 may be parallel to the cavity direction P1 and/or the longitudinal direction P2. Thereby, each pair of cavities 3 and connection members 5 may be positioned in the uncoupled state Q1, preferably essentially simultaneously. Moreover, each pair of cavities and connection members may transition to the coupled state Q2 by the relative displacement of the first 1 and second 2 joinery components along the coupling direction CD, preferably essentially simultaneously. The first 1 and second 2 joinery components may thereby be locked to each other, preferably in a final phase of the locking. Preferably, a third plane M3 extending along the face 2b and/or 2c is essentially arranged perpendicularly to the first plane M1 during locking and/or in the locked state, including the coupled state Q2. The locking may be accomplished without using a separate assembling tool.

The mounting side 1a and the mounting area 2a may be configured to cooperate, such as engage, with each other in the uncoupled state Q1 and/or during the relative displacement of the first 1 and second 2 joinery components along the coupling direction CD when transitioning to the coupled state Q2. The receiving portion 3e and the coupling portion 3f may be separated by a transition portion 3g.

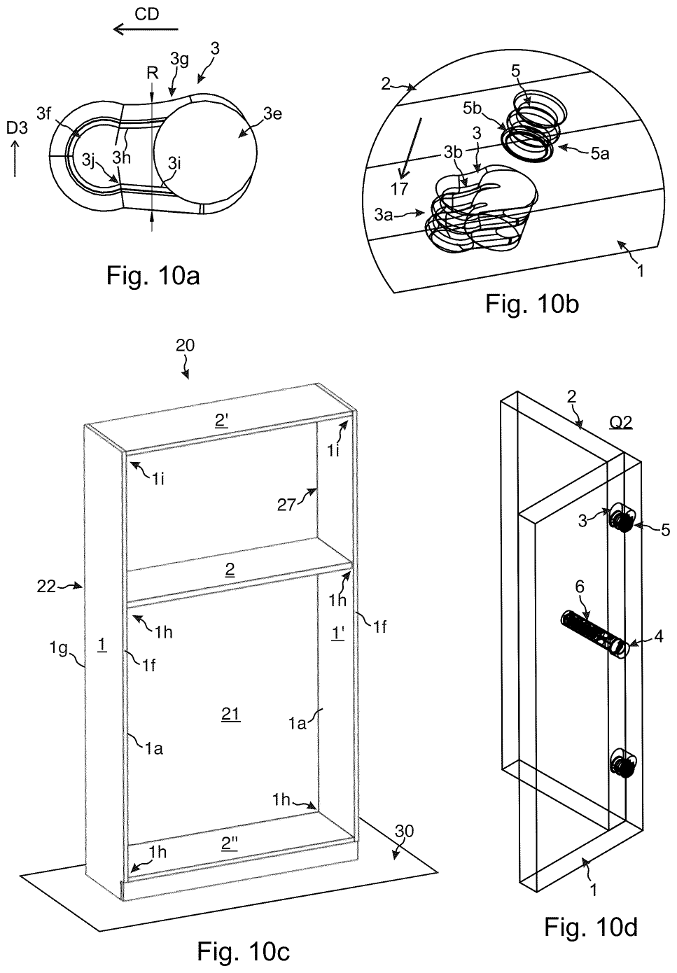

In some embodiments, and as shown in, e.g., FIGS. 3c-3e, a width R of the transition portion 3g may be constant along the coupling direction CD. The width R may be determined along the first plane M1 in the third direction D3 perpendicular to the second direction D2 and/or the coupling direction CD. Optionally, the third direction D3 may also be perpendicular to the first direction D1. At least a section of the transition portion 3g may comprise substantially parallel innermost opposing cavity walls 3h, 3i extending along the coupling direction CD. In some embodiments, and as shown in, e.g., FIGS. 10a-10b, the width R of the transition portion 3g may decrease along the coupling direction CD. At least a section of the transition portion 3g may comprise tapering innermost opposing cavity walls 3h, 3i extending along the coupling direction CD. For example, the tapering section may gradually increase the friction during the relative displacement of the cavities 3 and connection members 5. Optionally, the transition portion 3g in any of the embodiments above may be separated from the coupling portion 3f by a protrusion 3j. The protrusion 3j may be configured to locally increase the friction between the connection member 5 and the cavity 3 during the displacement and/or to provide a proper coupling indication.

In preferred embodiments, the insert 6 is separately formed from the second joinery component 2, for example formed by injection moulding. The insert 6 may comprise a polymer-based material, such as thermoplastic polymers. For example, the polymer-based material may comprise polyoxymethylene, POM, or polypropylene, PP, optionally comprising a reinforcing filler, such as glass fibers.

The connection members 5 and the insert 6 may extend at essentially the same angles b and g with respect to the second plane M2. The insert 6 may extend essentially along the normal direction N2 of the second plane M2, preferably such that an insert angle g between the main, such as axial, direction A of the insert 6 and a direction along the second plane M2, such as along the second direction D2, is 75°≤g≤105°, for example about 90°. In some embodiments, however, the insert angle g may deviate from the normal direction N2 by up to ±15°, such as being 75°≤g≤105° or 80°≤g≤100°. The insert groove 9 may extend in the same direction as the insert 6, whereby reference is made to the above values.

As shown in, e.g., FIGS. 2b, 4b, 6b and 7b, the insert 6, such as its enveloping surface, may have a substantially cylindrical shape, although other shapes are equally conceivable.

Generally herein, the insert 6 may be displaceable and/or compressible along its axial direction A, see the arrows C1 and C2 in FIGS. 2c-2d, 6c-6d, 7c, 7d and 9b illustrating an inward and outward displacement and/or (de-)compression, respectively. For example, the insert may be axially flexible along the axial direction A. The insert 6 may assume an expanded state S1 and a compressed state S2. For example, the insert may be at least partly compressed, such as entirely uncompressed, in the expanded state S1. The insert 6 may be configured to return towards, such as entirely to, the expanded state S1 when compressed by means of a biasing force. Thereby, it may function as a compression spring. An extension F1, F2 of the insert 6 along the axial direction A may be smaller in the compressed state S2 than in the expanded state S1. A, preferably maximal, extension F1 may be 30-60 mm, such as 45-55 mm. A, preferably maximal, extension F2 may be 25-55 mm, such as 40-50 mm.

The insert may comprise a spring, such as a static load spring. As seen most clearly in FIGS. 7c-7d, the insert 6 may comprise a flexible, compressible member 6b, preferably in the form of a plurality of joined serpentine elements 6c, which, for example, may be S-shaped elements. The serpentine elements 6c may be connected to a body portion 16 of the insert 6, preferably in an integral manner (one piece). Preferably, the serpentine elements 6c are exposed, such that they are visible around their entire circumference. At least a portion, such as an entirety, of the body portion 16 may be configured to be arranged in the insert groove 9 in the locked state, preferably engaging with a groove wall 9a and/or 9b of the insert groove 9. Preferably, the serpentine elements 6c are flexible. Moreover, the insert 6 may be configured to return towards the expanded state S1 when compressed by means of a biasing force of the serpentine elements 6c. The serpentine elements may thereby comprise alternating crests 6d and troughs 6e arranged along the axial direction A.

Adjacent serpentine elements 6c, such as adjacent crests 6d and/or troughs 6e, may be separated by a distance 28 in the expanded state S1. In non-limiting examples, the distance 28 may be 3-12 mm, such as 6-10 mm.

Adjacent serpentine elements 6c located along the same transverse side of the insert 6 may be separated by a space 6f along the axial direction A, at least in the expanded state S1, but optionally also in the compressed state S2. The space 6f may be configured to delimit the compression of the insert 6.

An angle d between adjacent serpentine elements 6c may be configured to increase during compression of the insert 6. For example, 15°≤d≤40°, such as 25°≤d≤35°. Alternatively, or additionally, the compressible member 6b of the insert 6 may be configured such that its width W1 does not substantially increase during compression of the insert 6. For example, the width W1 may stay substantially the same, such as increasing by less than 0.3 mm, such as less than 0.1 mm, or it may decrease. Alternatively, or additionally, the width W1 may stay substantially the same, such as increasing by less than 6%, such as less than 3%, such as less than 1%, or it may decrease. This may have the effect that a risk of pinching the compressible member 6b against the groove walls 9a, 9b when it is compressed may be reduced or entirely avoided.

In non-limiting examples, a spring constant of the compressible member 6b may be 3-20 N/mm, such as 5-15 N/mm, such as 8-12 N/mm.

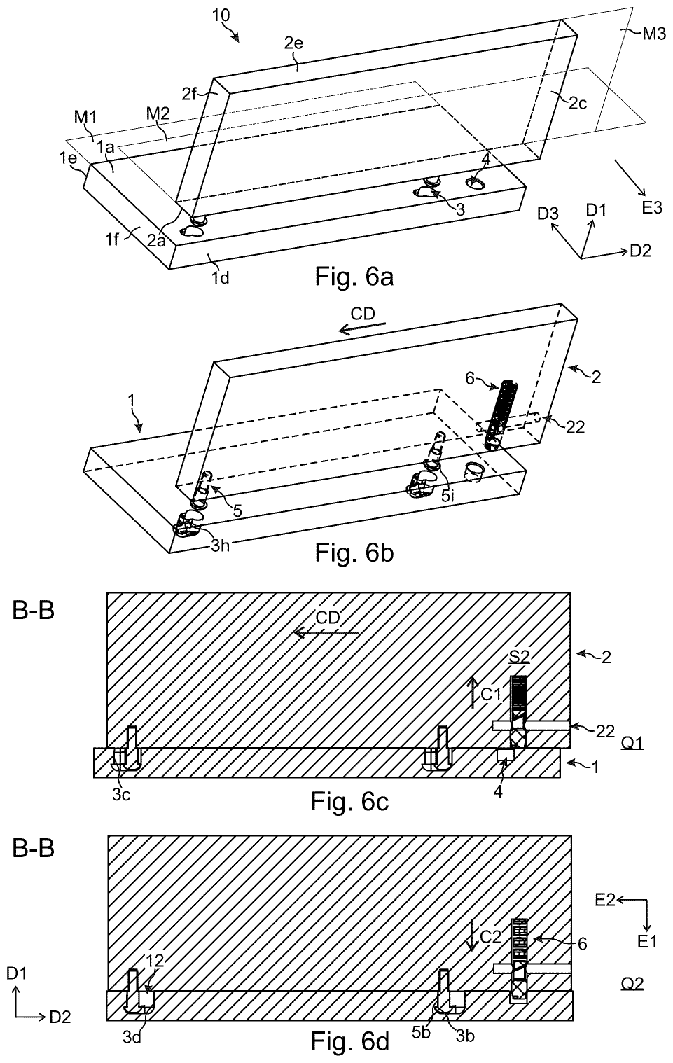

During locking, the insert 6 may be compressed such that it assumes the compressed state S2, and, subsequently, the insert 6 may be at least partially expanded towards the expanded state S1 for locking the joinery components 1, 2. For example, the insert 6 may be entirely expanded to the expanded state S1. The insert 6 may be compressed during locking by means of a cooperation between the insert 6 and the first joinery component 1, preferably the mounting side 1a, see, e.g., FIGS. 2c and 6c.

The insert 6 may be displaced during locking into the insert groove 9, preferably by being compressed such that it assumes the compressed state S2. Subsequently, the insert 6 may be displaced out from the insert groove 9, such that it at least partially is expanded towards the expanded state S1, for example entirely assuming the expanded state S1.

The insert 6 may comprise a head portion 6g, which preferably is generally tapering. For example, the head portion 6g may comprise a frustoconical head portion 6g. In non-restrictive examples, an inclination angle f between the head surface 8d of the head portion 6g and the main direction A may be 5°≤f≤20°, such as about 10°. The insert 6 may comprise a locking portion 6h configured to cooperate with a locking surface 4c of the recess 4, preferably arranged in a recess wall 4a, for locking the joinery components 1, 2 in the second direction D2. Preferably, in the locked state an outer portion 6i arranged opposite to the locking portion 6h is spaced from an oppositely arranged recess wall 4b by a play 14. For example, the recess wall 4b may be arranged oppositely to the recess wall 4a along the second direction D2. The locking portion 6h and the outer portion 6i may be provided in the head portion 6h. For example, in the locked state the locking portion 6h may be closer than the outer portion 6i to the cavities 3 and/or connection members 5 along the D2 direction. For example, a head length HL of the head portion 6g may be 3-7 mm, such as 4-6 mm.

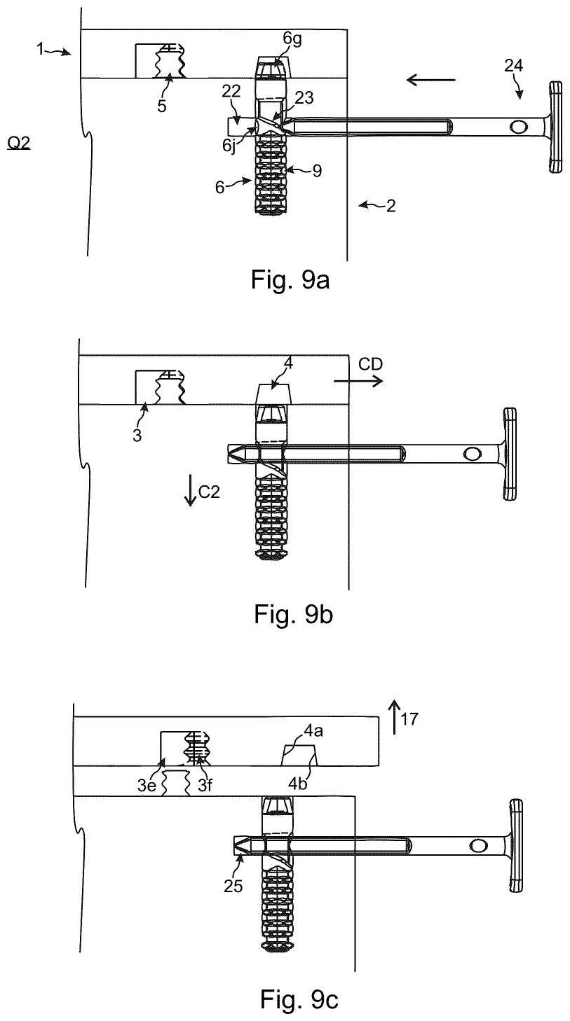

In some embodiments, the recess wall 4a may extend along the first direction D1, preferably by having parallel recess walls 4a, 4b. For example, the recess 4 may be shaped as a cylinder. In other embodiments, and as shown in FIGS. 9a-9c, the walls 4a, 4b may be frustoconically shaped.

In the locked state, the insert 6, such as a topmost portion 6a along the main direction A, may be spaced from a bottom wall 4d of the recess 4.

The joinery arrangement 10 herein may extend along a primary X, a secondary Y, and a tertiary Z direction, which are perpendicular to each other. At least in the locked state, the primary X and tertiary Z directions may extend along the first M1 and second M2 planes, and the secondary direction Y may extend along a thickness direction T of the first joinery component 1 and along the third plane M3.

For example, the third plane M3 may be configured to extend in parallel with a subfloor 30 in which the joinery arrangement 10 or joinery assembly 20 is to be installed, cf. FIG. 10c.

Generally herein, the faces and/or side edges and/or side portions of the joinery components 1, 2, such as all of them, may be rectangular or square, although other shapes are equally conceivable. In non-restrictive examples, a thickness T1, T2 of the joinery components 1, 2, such as along the first D1 or third D3 direction, may be 10-32 mm, preferably 12-19 mm. Moreover, in non-restrictive examples, the dimensions of the faces 1b, 2b, 1c, 1c may be between 50 mm and 2500 mm.

The quantities specified herein, such as the angles [symbol] , b, g, d, f, s or the extensions CE, F1, F2, HL, K, L, O1, O2, R, T1, T2, U1, U2, U1′, U2′, V1, V2, V1′, V2′, W1-W3, WR, 7, 26, 28 may be determined by means of a profile projector, for example from Mitutoyo or Dravitec AB, preferably in an unlocked state.

FIG. 10c illustrates an embodiment of a joinery assembly 20 comprising the joinery arrangement 10 and/or inserts 6 according to any of the embodiments shown in, e.g., FIGS. 1a-1c, 2a-2d, 3a-3e, 4a-4d, 5a-5c, 6a-6d, 7a-7d, 8a-8f, 9a-9c, 10a-10b and 10d, and further comprising at least one additional joinery component 1, 1′, 2, 2′, 2″ such as a plurality of additional joinery components. This particular embodiment includes two joinery arrangements 10 with three second joinery components 2, 2′, 2″ locked to the same first joinery component 1 and 1′. The first joinery component 1′ may be embodied similarly to the first joinery component 1 and the second joinery components 2′, 2″ may be embodied similarly to the second joinery component 2. The mounting side 1a may be an inner first face 1b of the joinery assembly 20. The joinery assembly 20 may be a furniture assembly, for example a cabinet assembly, a drawer assembly or a shelf assembly. Optionally, one or several of the joinery components 1, 1′, 2′, 2″ may comprise a connecting channel 27 for connecting a backside joinery component 21 to them. It is emphasized that the mechanical locking device described herein may be arranged in an interior portion 1h and/or in a corner section 1i of the first face 1b.

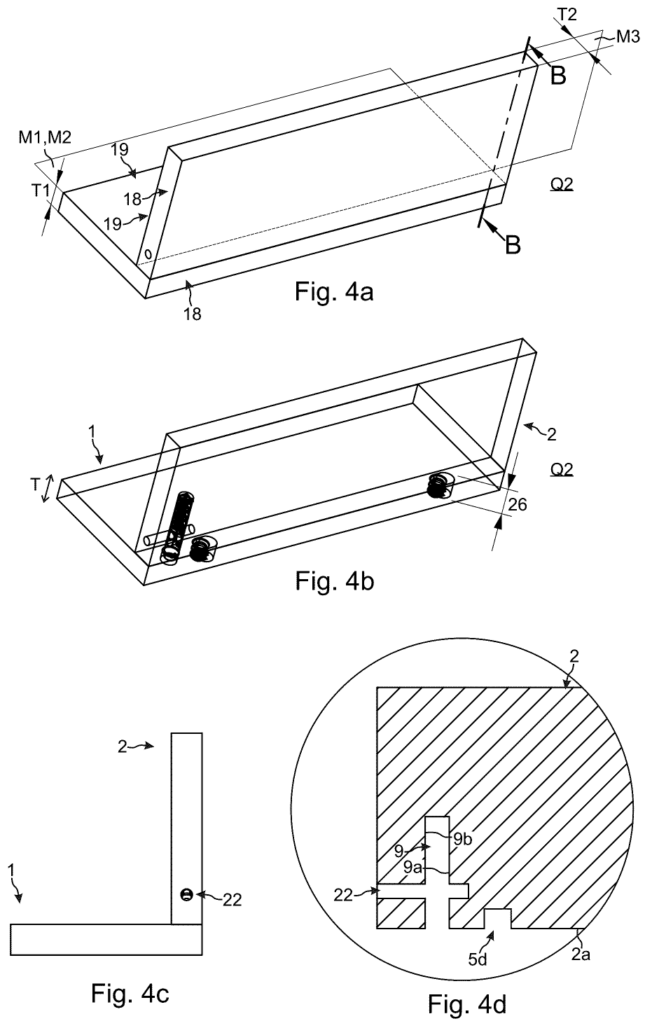

As shown most clearly in FIGS. 1a-1c, 2a-2d, 3a-3b, 5a-5c, 6a-6d, 8a-8b and 9a-9c, in some embodiments the recess 4 may be arranged in an edge portion 11a of the joinery component 1 and/or the insert 6 may be arranged in an edge section 11b of the second joinery component 2. For example, the recess 4 may be arranged outside of each cavity 3 along the second direction D2 and the insert 6 may be arranged outside of each connection member 5 along the second direction D2. Thereby, an unlocking hole 22 of the second joinery component 2 may be more easily concealed, cf. FIGS. 9a-9c. It is noted, however, that in some embodiments, the recess 4 (and insert 6) may be arranged between a pair of cavities 3 (and connection members 5) as illustrated in FIG. 10d, and as shown and discussed in relation to, e.g., FIGS. 4-10 in WO 2024/019644 A1, which content hereby is explicitly incorporated by reference. As indicated in FIG. 10d, the cavities 3, the recess 4, the connection members 5 and the insert 6, including the insert groove 9, may be embodied as in any of FIGS. 1a-1c, 2a-2d, 3a-3c, 4a-4d, 9a-9c, and 10a- 10b, whereby reference is made thereto. Alternatively, however, the connection members 5 in FIG. 10d may be embodied as in any of FIGS. 3d-3e, 5a-5c, 6a-6d, 7a-7b and 8a-8b, whereby reference is made thereto.

The unlocking hole 22 may be configured to communicate with the insert groove 9 for providing access to an opening 6j of the insert 6. The joinery components 1, 2 may be configured to be unlocked by inserting a tool 24 into the unlocking hole 22 and through the opening 6j, see FIG. 9a. Preferably, the tool 24 comprises a tapering tip 25. The opening 6j may comprise a slanted surface 23, and the cooperation between the tool 24 and the slanted surface 23 may displace and/or compress the insert 6 along the main direction A such that the insert 6, preferably at least the head portion 6g, may be displaced out from the recess 4, see FIG. 9a. Thereafter, the cavities 3 and connection members 5 may transition from the coupled state Q2 to the uncoupled state Q1 by a relative displacement of the joinery components 1, 2 along the coupling direction CD, which also may be an uncoupling direction (directed oppositely). Finally, the first 1 and second 2 joinery components may be relatively displaced along the locking direction 17, which may also be an unlocking direction (directed oppositely), such that the connection members 5 may be separated from the cavities 3.

According to one aspect of the disclosure, there is a provided a kit-of-parts comprising the first 1 and the second 2 joinery components, the connection members 5 and the insert 6 of the joinery arrangement 10 according to any embodiment described herein. The interaction between the parts have been detailed elsewhere herein, whereby reference is made thereto. Such a kit-of-parts may be arranged in a package.

Aspects of the disclosure have mainly been described above with reference to a few embodiments. However, as is readily appreciated by a person skilled in the art, other embodiments than the ones disclosed above are equally possible within the scope of the disclosure.

### EMBODIMENTS

Item 1. A joinery arrangement (10) comprising a first joinery component (1) and a second joinery component (2) configured to be locked to each other to obtain a locked state, wherein:
a mounting side (1a) of the first joinery component (1) comprises at least one cavity (3) and a recess (4), and
a mounting area (2a) of the second joinery component (2) comprises at least one protruding connection member (5) and an insert (6), the insert being displaceable and/or compressible along its main direction (A),
said at least one cavity (3) and said at least one connection member (5) being configured to transition from an uncoupled state (Q1) to a coupled state (Q2) and/or configured to transition from the coupled state (Q2) to the uncoupled state (Q1) by a relative displacement of the first (1) and second (2) joinery components along a coupling direction (CD) extending along a first plane (M1) extending along the mounting side (1a) of the first joinery component,
   wherein said at least one cavity (3) and said at least one connection member (5) comprise a locking member (3a) and a locking element (5a) configured to cooperate with each other in the coupled state (Q2) for locking the first (1) and second (2) joinery components to each other in a first direction (D1) perpendicular to the first plane (M1), and
   wherein the recess (4) and the insert (6) are configured to cooperate with each other in the coupled state (Q2) for locking the first (1) and second (2) joinery components to each other in a second direction (D2) along said first plane (M1).

Item 2. The joinery arrangement according to item 1, wherein a width (V1; V1′) of the cavity (3) varies along a longitudinal cavity direction (P1) and wherein a width (V2; V2′) of the connection member (5) varies along a longitudinal direction (P2) of the connection member (5).

Item 3. The joinery arrangement according to item 1 or 2, wherein the locking member (3a) and the locking element (5a) comprise at least two pairs of locking surfaces (13; 15) for locking the first (1) and second (2) joinery components to each other in the first direction (D1).

Item 4. The joinery arrangement according to any of the preceding items, wherein said at least one cavity (3) is configured to receive said at least one connection member (5) by a relative displacement of the first (1) and second (2) joinery components along a locking direction (17) extending along the first direction (D1), such as only along the first direction (D1).

Item 5. The joinery arrangement according to any of the preceding items, wherein the at least one cavity (3) and the at least one connection member (5) are further configured to cooperate with each other for locking the first (1) and second (2) joinery components to each other along the second direction (D2), preferably in a direction (E2) opposite to the second direction (D2) in which the recess (4) and the insert (6) are configured to lock.

Item 6. The joinery arrangement according to any of the preceding items, wherein each cavity (3) comprises a receiving portion (3e) and a coupling portion (3f), a width (V1) of the cavity (3) along the coupling direction (CD) not exceeding 2.5, such as not exceeding 2.0, times a width (WR) of the receiving portion (3e) along the coupling direction (CD).

Item 7. The joinery arrangement according to any of the preceding items, wherein the mounting side (1a) of the first joinery component (1) is provided in a first face (1b) of the first joinery component and wherein the mounting area (2a) is provided in a first side edge (2d) of the second joinery component (2).

Item 8. The joinery arrangement according to any of the preceding items, wherein the mounting side (1a) of the first joinery component (1) comprises at least two cavities (3) and the mounting area (2a) of the second joinery component (2) comprises at least two connection members (5).

Item 9. The joinery arrangement according to any of the preceding items, wherein a longitudinal direction (P2) of the at least one connection member (5) extends along a normal direction (N2) of a second plane (M2) extending along the mounting area (2a) of the second joinery component (2).

Item 10. The joinery arrangement according to any of the preceding items, wherein said at least one cavity (3) and said at least one connection member (5) are further configured to cooperate with each other in the coupled state (Q2) for locking the first (1) and second (2) joinery components to each other in a third direction (D3) which is perpendicular to the first (D1) and second (D2) directions.

Item 11. The joinery arrangement according to any of the preceding items, wherein the coupling direction (CD) extends along the second direction (D2).

Item 12. The joinery arrangement according to any of the preceding items, wherein, during locking, the insert (6) is configured to be compressed such that it assumes a compressed state (S2), and wherein, subsequently, the insert (6) is at least partially expanded towards an expanded state (S1) for locking the second joinery component (2) to the first joinery component (1).

Item 13. The joinery arrangement according to any of the preceding items, wherein the mounting side (1a) and the mounting area (2a) are configured to cooperate with each other in the uncoupled state (Q1), and/or during the relative displacement of the first (1) and second (2) joinery components along the coupling direction (CD).

Item 14. The joinery arrangement according to any of the preceding items, wherein the second joinery component (2) is configured to be locked to the first joinery component (1) by relatively displacing the second joinery component (2) with respect to the first joinery component (1) along the coupling direction (CD).

Item 15. The joinery arrangement according to any of the preceding items, wherein the insert (6) is arranged in an insert groove (9) of the second joinery component (2).

Item 16. The joinery arrangement according to item 15, wherein the second joinery component (2) comprises an unlocking hole (22) configured to communicate with the insert groove (9) for providing access to an opening (6j) of the insert (6), the first (1) and second (2) joinery components being configured to be unlocked by inserting a tool (24) into the unlocking hole (22) and through the opening (6j).

Item 17. The joinery arrangement according to any of the preceding items, wherein the insert (6) and/or an insert groove (9) in which the insert (6) is configured to be arranged essentially extends along a normal direction (N2) of a second plane (M2) extending along the mounting area (2a) of the second joinery component (2).

Item 18. The joinery arrangement according to any of the preceding items, wherein the insert (6) comprises a locking portion (6h) and an outer portion (6i) arranged opposite to said locking portion (6h), wherein, in the locked state:
the locking portion (6h) is configured to cooperate with a locking surface (4c) of the recess (4) arranged in a recess wall (4a) for locking the first (1) and the second (2) joinery components in the second direction (D2), and
the outer portion (6i) is spaced from an oppositely arranged recess wall (4b) by a play (14).

Item 19. The joinery arrangement according to any of the preceding items, wherein a head portion (6g) of the insert (6) is generally tapering, such as comprising a frustoconical head surface (8d).

Item 20. The joinery arrangement according to any of the preceding items, wherein a compressible member (6b) of the insert (6), preferably in the form of a plurality of joined serpentine elements (6c), is configured such that its width (W1) does not increase during compression of the insert (6).

Item 21. A joinery assembly (20) comprising the joinery arrangement (10) according to any of the preceding items 1-20, further comprising at least one additional joinery component (1′; 2; 2′).

1. A joinery arrangement comprising a first joinery component and a second joinery component configured to be locked to each other to obtain a locked state, wherein:
a mounting side of the first joinery component comprises at least one cavity and a recess, and
a mounting area of the second joinery component comprises at least one protruding connection member and an insert, the insert being displaceable and/or compressible along its main direction,
said at least one cavity and said at least one connection member being configured to transition from an uncoupled state to a coupled state and/or configured to transition from the coupled state to the uncoupled state by a relative displacement of the first and second joinery components along a coupling direction extending along a first plane extending along the mounting side of the first joinery component, wherein said at least one cavity and said at least one connection member comprise a locking member and a locking element configured to cooperate with each other in the coupled state for locking the first and second joinery components to each other in a first direction perpendicular to the first plane,
wherein the insert comprises a plurality of joined serpentine elements, the serpentine elements being connected to a body portion of the insert in an integral manner, and
wherein the insert comprises a polymer-based material, and
wherein the recess and the insert are configured to cooperate with each other in the coupled state for locking the first and second joinery components to each other in a second direction along said first plane.

2. The joinery arrangement according to claim 1, wherein a width of the cavity varies along a longitudinal cavity direction and wherein a width of the connection member varies along a longitudinal direction of the connection member.

3. The joinery arrangement according to claim 1, wherein the locking member and the locking element comprise at least two pairs of locking surfaces for locking the first and second joinery components to each other in the first direction.

4. The joinery arrangement according to claim 1, wherein said at least one cavity is configured to receive said at least one connection member by a relative displacement of the first and second joinery components along a locking direction extending along the first direction.

5. The joinery arrangement according to claim 1, wherein the at least one cavity and the at least one connection member are further configured to cooperate with each other for locking the first and second joinery components to each other along the second direction.

6. The joinery arrangement according to claim 1, wherein each cavity comprises a receiving portion and a coupling portion, a width of the cavity along the coupling direction not exceeding 2.5 times a width of the receiving portion along the coupling direction.

7. The joinery arrangement according to claim 1, wherein the mounting side of the first joinery component is provided in a first face of the first joinery component and wherein the mounting area is provided in a first side edge of the second joinery component.

8. The joinery arrangement according to claim 1, wherein the mounting side of the first joinery component comprises at least two cavitie and the mounting area of the second joinery component comprises at least two connection members.

9. The joinery arrangement according to claim 1, wherein a longitudinal direction of the at least one connection member extends along a normal direction of a second plane extending along the mounting area of the second joinery component.

10. The joinery arrangement according to claim 1, wherein said at least one cavity and said at least one connection member are further configured to cooperate with each other in the coupled state for locking the first and second joinery components to each other in a third direction which is perpendicular to the first and second directions.

11. The joinery arrangement according to claim 1, wherein the coupling direction extends along the second direction.

12. The joinery arrangement according to claim 1, wherein, during locking, the insert is configured to be compressed such that it assumes a compressed state, and wherein, subsequently, the insert is at least partially expanded towards an expanded state for locking the second joinery component to the first joinery component.

13. The joinery arrangement according to claim 1, wherein the mounting side and the mounting area are configured to cooperate with each other in the uncoupled state, and/or during the relative displacement of the first and second joinery components along the coupling direction.

14. The joinery arrangement according to claim 1, wherein the second joinery component is configured to be locked to the first joinery component by relatively displacing the second joinery component with respect to the first joinery component along the coupling direction.

15. The joinery arrangement according to claim 1, wherein the insert is arranged in an insert groove of the second joinery component.

16. The joinery arrangement according to claim 15, wherein the second joinery component comprises an unlocking hole configured to communicate with the insert groove for providing access to an opening of the insert, the first and second joinery components being configured to be unlocked by inserting a tool into the unlocking hole and through the opening.

17. The joinery arrangement according to claim 15, wherein the insert and/or an insert groove in which the insert is configured to be arranged essentially extends along a normal direction of a second plane extending along the mounting area of the second joinery component.

18. The joinery arrangement according to claim 1, wherein the insert comprises a locking portion and an outer portion arranged opposite to said locking portion, wherein, in the locked state:
the locking portion is configured to cooperate with a locking surface of the recess arranged in a recess wall for locking the first and the second joinery components in the second direction, and
the outer portion is spaced from an oppositely arranged recess wall by a play.

19. The joinery arrangement according to claim 1, wherein a head portion of the insert is generally tapering.

20. The joinery arrangement according to claim 1, wherein a compressible member of the insert is configured such that its width does not substantially increase during compression of the insert.

21. A joinery assembly comprising the joinery arrangement according to claim 1, further comprising at least one additional joinery component.
